(19) United States
(12) Patent Application Publication
(10) Pub. No.: US 2026/0195739 A1
(43) Pub. Date: Jul. 9, 2026

(54) SYSTEM FOR TOKENIZING SENSITIVE DATA DURING INTERACTIONS WITH EXTERNAL SYSTEMS

(71) Applicants: Peter Rozovski, Concord, CA (US); Sergiy Pikusov, Santa Clara, CA (US); Wei Zhou, MOORESVILLE, NC (US)

(72) Inventors: Peter Rozovski, Concord, CA (US); Sergiy Pikusov, Santa Clara, CA (US); Wei Zhou, MOORESVILLE, NC (US)

(21) Appl. No.: 19/009,750

(22) Filed: Jan. 3, 2025

(51) Int. Cl. G06Q 20/38; G06Q 20/40

(52) U.S. Cl. CPC G06Q 20/382; G06Q 20/401

(57) ABSTRACT

Various systems and methods for tokenizing sensitive data are described herein. A system can be configured to receive, from a client device, an electronic indication to initiate processing of transactions; determine whether a transactional flow is inbound or outbound; populate a staging table in a database with at least one of an account number and a token, the token being a tokenized value of the account number; update the staging table with account numbers given values of tokens in the staging table when the transactional flow is outbound, and update the staging table with tokens given the account numbers in the staging table when the transactional flow is inbound; and process the transactions using the updated tokens or account numbers in the staging table.

### BACKGROUND

Tokenizing sensitive data is a security technique that involves replacing sensitive information (like credit card numbers, Social Security numbers, or personal identifiers) with a non-sensitive character string called a token. This token can be stored and used in place of the actual data, reducing the risk of exposure if the system storing the tokens is compromised. Tokenizing (or tokenization) may be irreversible, which means that there is no mathematical relationship available to be able to obtain the original data from the token. Tokens allow businesses to minimize the risk of exposing sensitive data, especially in systems like payment processing, customer relationship management (CRM), or healthcare. In case of a data breach, the compromised tokens would be meaningless to attackers without access to the token vault.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a diagram illustrating data and control flow, according to an embodiment;

FIG. 3 is a diagram illustrating the four types of Bill Pay transactions, according to an embodiment;

FIG. 4 is a diagram illustrating a process for tokenizing a primary account number (PAN), according to an embodiment;

FIG. 5 illustrates the data and control flow in a system, according to an embodiment;

FIG. 6 is a diagram illustrating the operational flow for inbound and outbound batch pipelines, according to an embodiment;

FIG. 7 is a flowchart illustrating a method for processing Bill Pay transactions, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide mechanisms for tokenizing sensitive data. In the financial services industry, software applications often use account numbers when perform operations on customer accounts. A primary account number (PAN) is one such account number. For instance, the PAN may be a certain number of digits (e.g., 12-19, 13-19, etc.) that appears on a credit, debit, or prepaid card. It is an identifier issued by the card-issuing bank or financial institution. The PAN identifies the cardholder's account and contains information about the card issuer and the card type. Such PAN numbers are targets for hackers. Tokenization is used to increase security in this space. In a financial institution system, there is a dedicated system that stores PAN numbers in plaintext and their corresponding token values. Other systems and applications in the financial institution system are then able to use tokens without storing or referring to real PAN numbers. That reduces the attack surface to that of the dedicated system that stores the records relating the real PAN numbers and their corresponding tokens.

However, Bill Pay systems continue to have security issues because Bill Pay uses external payment processors. These external payment processors do not understand the token values, which are private to a financial institution. In general, Bill Pay systems collect requests for payments from Bill Pay customers, and then sends the requests to one or more payment processors. If the payment processor is internal to the Bill Pay system, meaning that the payment processor and the Bill Pay system are hosted by the same financial institution, then the Bill Pay system can pass the payment request using a token known by the financial institution system. The internal payment processor can retrieve the actual PAN and use it when completing the transaction.

However, if the payment processor is external to the Bill Pay system (e.g., hosted by an external or foreign financial institution, intermediate payment processor network, etc.), then Bill Pay system cannot use tokens because the external systems do not understand the mapping between the token and the real PAN. As such, for inter-system transactions, Bill Pay systems have to use the real PAN. This introduces a security risk that is addressed by the systems and methods described herein.

There are several challenges when using external payment processors. First, generating the files to send to external payment processors is tedious and time consuming. Tokens need to be replaced with actual account numbers, which involves many database queries and other processing and communication overhead. Second, payment processors may have different file formats, formatting requirements, and other processor-specific configurations that make a general solution difficult to implement. Third, a variety of different account number types are used when using Bill Pay. Along with PAN numbers, some Bill Pay transactions use a non-PAN account number such as a home mortgage account number, a gas and electric company account number, a water company account number, a cellular phone account number, etc. As such, when constructing the Bill Pay files, tokenized PAN numbers have to be handled differently than non-PAN account numbers that are not tokenized.

What is needed is a more robust security mechanism that can protect account numbers when transactions are sent to external payment processors. The system uses a hashing scheme when creating a token from a PAN and then a lookup to resolve the PAN from the token. The PAN is left in the clear for a limited time to reduce security risks. The format of the tokenized account number may be configured to further provide processing efficiencies while providing additional security features. These functions and others are described in more detail below.

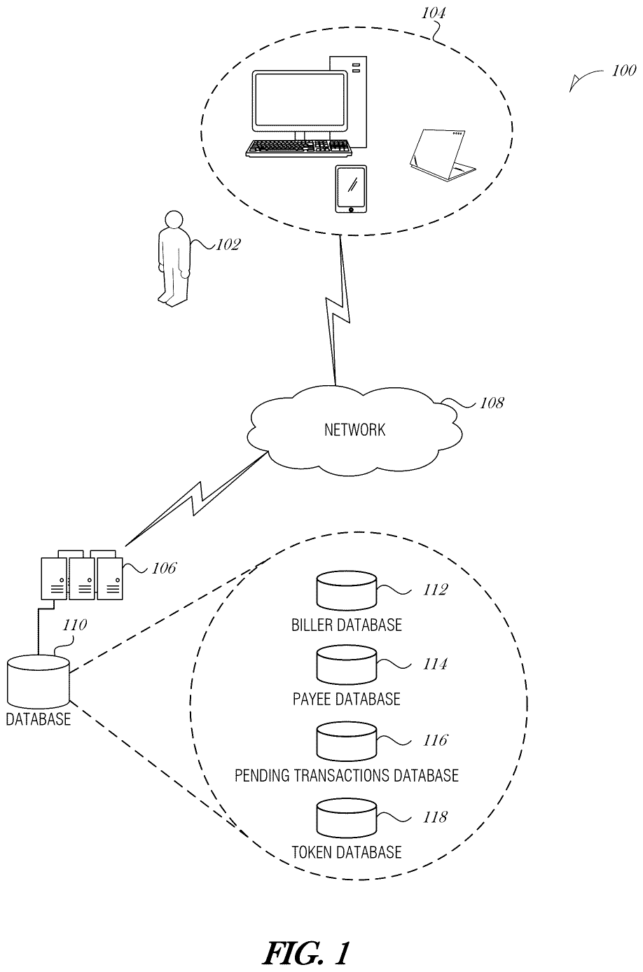

FIG. 1 is a diagram illustrating an operating environment 100, according to an embodiment. A user 102 may use a user device 104 to access a financial institution computing system 106. The financial institution computing system 106 may be operated by or incorporated with a larger computing system used by one or more financial institutions. The user device 104 may be of any type of form factor including, but not limited to a desktop computer, a mobile device, a laptop computer, a smartphone, a tablet device, a personal digital assistant, or the like. The user 102 may be a person who fulfils a role, such as a system administrator, a business executive, a group manager, a business unit administrator, a financial advisor, a financial analyst, a business analyst, an accounting clerk, or the like. Each role may have different permissions to execute functions or operations in the financial institution computing system 106. For instance, an administrator may be allowed to create a new database tasks, delete an existing database task, or revise a database task. A person with a non-elevated privilege (e.g., a regular user) may only have permissions to submit queries to the financial institution computing system 106 or execute existing available tasks, which operate on data in the financial institution computing system 106.

Database tasks may be implemented with a combination of one or more stored procedures, scripts, processes, queries, reports, microservices, or the like, which operate to retrieve data from the database 110, transform the data, and store transformed data in the database 110. Database tasks may be integrated into a database management system (DBMS) or may be implemented as separate from the DMBS. Database tasks may be implemented in standalone executable applications that access a database 110.

Alternatively, the user 102 may be a customer of the financial institution computing system 106. For instance, the user 102 may be a banking customer of a bank that operates the financial institution computing system 106. The user 102 may interact with the financial institution computing system 106 through user interfaces provided by the bank, such as an online banking experience, through a mobile app, or by interactive voice response (IVR). The user 102 may perform a number of different financial transactions, such as to transfer funds between accounts, deposit or withdraw money, check balances, or schedule online payments.

The financial institution computing system 106 may include various web servers, database servers, proxy devices, firewalls, storage devices, and network devices. The financial institution computing system 106 may provide a web-based interface accessible via a uniform resource locator (URL). The financial institution computing system 106 may provide various levels of security, such as requiring an account with a username and password, a secure channel (e.g., HTTPS), two-factor authentication, and the like.

To connect to the financial institution computing system 106, the user 102 may execute an application (“app”) on the user device 104 to connect via a network 108. The app may be an internet browser application, a database query client application, a database console application, a custom user interface with a database interconnection to the financial institution computing system 106, or the like. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area networks, or peer-to-peer (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in the financial institution computing system 106 may be organized and stored in a variety of manners. For convenience, the organized collection of data is described herein as a database 110. The specific storage layout and model used in the database 110 may take a number of forms. The database 110 may utilize multiple models. The database 110 may be, but is not limited to, a relational database (e.g., SQL), non-relational database (NoSQL), a flat file database, object model, document details model, or a file system hierarchy. The database 110 may be implemented using MongoDB using a JavaScript Object Notation (JSON) or other data serialization file data format. The database 110 may store data on one or more storage devices (e.g., a hard disk, random access memory (RAM), etc.). The database 110 may include a cache database, such as Redis, to cache some or all of the database contents. The storage devices may be in standalone arrays, part of one or more servers, and may be located in one or more geographic areas.

A database management system (DBMS) may be used to access the data stored within the database 110. The DBMS may offer options to search the database 110 using a query and then return data in the database 110 that meets the criteria in the query. The DBMS may provide an interface to create, edit, or manage database tasks. The DBMS may be implemented, at least in part, with MongoDB Atlas. The DBMS may operate on one or more of the components of the financial institution computing system 106.

Every day, financial institution customers create millions of new online payments. A financial institution may use multiple payment processors (both internal and external to the financial institution) to process payments. These payment processors cost money to process payments. The rates for payment processing are different for different payment processors and payment types (electronic or paper, internal or external, etc.). Some payments can only be processed by one payment processor. However, a majority of payments can be processed by more than one payment processor.

As used herein, a biller is defined as a tuple of at least an organization and a remittance addresses. An organization is any company, business, person, or the like that provides goods or services to a customer and then invoices the customer for those goods or services. Billers may be creditors, such as a credit card company, which offers a line of credit to a customer and invoices the customer monthly for charges against the line of credit. For instance, a credit card company “CREDIT ABC” may provide a credit card affiliated with the VISA payment card processing network. The credit card company may have several regional remittance locations to serve its national customer base. For instance, CREDIT ABC may have a west coast location in San Francisco, California, a mid-west location in Chicago, Illinois, and an east coast location in Atlanta, Georgia. In the database 110, there are three biller identifications, one for each combination of CREDIT ABC and the respective west, mid-west, and east coast locations. Thus, for CREDIT ABC, there are at least three biller entries in the database 110, each of which is a combination of organization and remittance address (e.g., there may be more than one remittance address in use in Chicago).

As used herein, a payee is defined as a tuple of at least an organization, a remittance address, a customer account number, a token, and a token flag. Each payee is unique to a customer. In general, a payee contains the information of the biller plus the customer's account number. The token is a tokenized version of the account number. The format of the token is described in more detail below. The token flag may be a character, Boolean, or other type of value to store whether the account number is tokenized or not. For instance, a token flag=TRUE may be used to indicate that the customer account number is tokenized with the corresponding value in the token field. A value of NULL or FALSE may be used to indicate that the customer account number is not tokenized. As discussed above, some customer account numbers are not tokenized, such as a mortgage account number, a cellular phone account number, etc. In an embodiment, only primary account numbers (PAN) are tokenized. PANs are typically credit card numbers that are specially formatted and having a certain number of digits (e.g., thirteen digits, sixteen digits, fifteen digits, etc.) in length. The number of digits may be in a standard range (e.g., 12-19 or 13-19 digits) used in PAN values.

To store biller and payee information, the database 110 may include a biller database 112 and a payee database 114. The biller database 112 may contain profiles for a plurality of billers, including, for example, each biller's full name, aliases, previous names, phone number, remittance address, and the like. Multiple biller profiles for a given billing organization may exist in the biller database 112. For instance, there may be separate biller profiles for the same billing organization, where each biller profile is for a different remittance address of the billing organization. In some arrangements, customers (e.g., user 102) can send a request to the financial institution computing system 106 to add a specific biller to the biller database 112 by providing information sufficient to complete a biller profile.

The biller database 112 can be stored in the financial institution computing system 106 on any of several electronic storage mediums such as disc-based or flash-based hard drives, local servers, offsite cloud-based servers, or a combination thereof. Although the biller database 112 is represented as a single unit in FIG. 1, the biller database 112 can be divided and stored in several storage mediums of varying types and in different, even remote, locations.

The payee database 114 may contain profiles of a plurality of payees, including, for example, each payee's full name, alias, customer account number, token, token flag, and the like. Multiple payee profiles for a given biller may exist in the payee database 114. For instance, there may be separate payee profiles for the same biller, where each payee profile is for a different customer account of the biller (a home mortgage account, a home line of credit account, and a car loan account, all at the same bank). In some arrangements, customers (e.g., user 102) can send a request to the financial institution computing system 106 to add a specific payee to the payee database 114 by providing information sufficient to complete a payee profile. This is useful for private companies or individual payees, such as a personal payee (e.g., an individual person, a married couple, a babysitter, etc.) or a small business (e.g., a lawn mowing service, etc.).

The payee database 114 can be stored in the financial institution computing system 106 on any of several digital storage mediums such as disc-based or flash-based hard drives, local servers, offsite cloud-based servers, or a combination thereof. Although the payee database 114 is represented as a single unit in FIG. 1, the payee database 114 can be divided and stored in several storage mediums of varying types and in different, even remote, locations.

The database 110 includes pending transactions including pending payment transactions to payees. The pending transactions may be stored in the payee database 114 or in a separate database (e.g., pending transactions database 116) that references the payee database 114. When a customer accesses the financial institution computing system 106 to create a new scheduled payment for a payee, the pending payment transaction is stored in the database 110. The customer may schedule the payment to be paid non-electronically (e.g., by paper check, bank draft, cashier's check, money order, or the like). These types of payments cost the financial institution more than if the payment were to be sent electronically. Thus, where possible, non-electronic payments may be re-routed to electronic payments.

The database 110 also includes a token database 118. The token database includes at least the fields: primary account number (PAN), token, and token flag. The PAN is an account number from twelve to seventeen digits. The token is a string that is the result of a tokenization process that was performed on the PAN. The token flag is an indication of whether the PAN is tokenized or not. In the case when the PAN is not tokenized, the token field may optionally be populated with the PAN, a NULL value, or some other arbitrary non-value (e.g., “000000000000”).

In an embodiment, the token is formatted to have the same length as the PAN. So, if the PAN is twelve digits, then the token is also twelve digits. In another embodiment, the last four digits of a token are configured to be the same as the last four digits of the PAN. This provides easier cross-referencing and optimizes some processes that use the last four digits of a PAN during processing. In this way, the financial institution computing system 106 can use tokens in place of PAN values throughout to obfuscate the real account numbers and provide additional security.

A token-to-PAN mapping is unique such that when a function (e.g., microservice, task, process, etc.) is executed used to retrieve a PAN, given a token, then the same PAN is returned, and the process is repeatable and dependable.

Two functions are available to users 102, a PAN-to-Token function (getToken) and a Token-to-Pan function (getPAN). The getToken function takes a primary account number as input and returns a token value. In an embodiment, the getToken function returns a token of the same length as the input PAN. In another embodiment, the getToken function returns a token having the same last four digits as the input PAN.

The getPAN function takes a token value as input and returns a PAN. The tokens and corresponding PANs may be stored in one or more secure tables in the database 110, such as in the payee database 114 or the token database 118. It is a goal of the financial institution computing system 106 to minimize the places and the time that the PANs are stored in the clear. In as many places as possible, the financial institution computing system 106 relies on the tokens to process transactions. The actual PAN values are only used when necessary, such as when sending transactions off platform for processing at an external system.

In order to increase processing efficiencies, one or more staging tables may be used in the database 110. A staging table includes the PAN, the token, and the token flag. The staging table may be populated for a batch process (e.g., a process that operates on a number of pending transactions) so that the getPAN or getToken function is not called repeatedly for every pending transaction. The staging table may be populated for a limited time and then cleared to reduce the time that PAN values are stored in the clear.

The getPAN and getToken functions may be implemented as microservice endpoints accessible via an application programming interface (API). Calls to the API may be performed using Hypertext Transfer Protocol (HTTP) messaging protocols, such as with an eXtended Markup Language (XML) Simple Object Access Protocol (SOAP) message or using Representational State Transfer (REST) mechanisms. One or more microservices may be distributed across hosting regions in the financial institution computing system 106 with no shared points of failure for any one functional fault domain. This provides redundancy and resiliency, meaning no two microservices can share the same host, virtual machine (VM), disk, or compute resource. Services may be distributed as being redundant across network resources meaning regionally redundant and accessed by separate circuits.

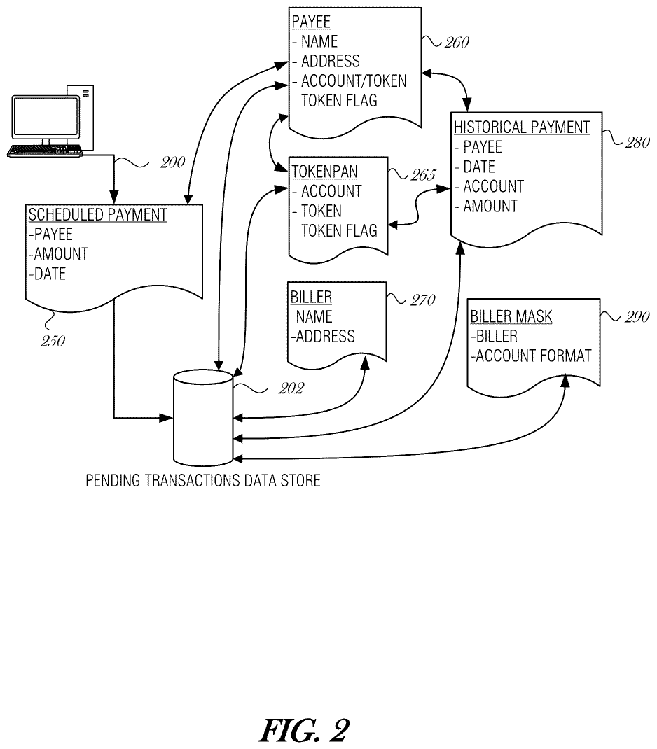

FIG. 2 is a diagram illustrating data and control flow, according to an embodiment. A user creates a scheduled payment to a payee (operation 200). The payee may be one of several payees available to the user for selection. As described above, the payee may be configured by the user based on the user's information of the payee.

The scheduled payment data structure 250 includes at least a reference to a payee data structure 260 (e.g., using a foreign key), a payment date, a payment amount, and optionally other information, such as a memo or note describing the payment. The payee data structure 260 includes at least a payee name, a payee address, a customer account number with the payee, and a token flag. When the token flag is set to indicate that the customer account number is tokenized, then the value of the customer account number is the value of the token. When the token flag is set to indicate that the customer account number is not tokenized, then the customer account number is a non-PAN account type, and the customer account number is the actual account number.

The tokenPAN data structure 265 includes at least an account number, a token, and a token flag. The tokenPAN data structure 265 may be the sole data structure (e.g., database table or database file) that holds the extremely sensitive relationships between the PAN and the token value. To minimize security risks, the tokenPAN data structure 265 may be secured using access controls, security monitoring, encryption, or other mechanisms. For instance, the access to the tokenPAN data structure 265 may be limited to the getPAN and getToken functions described above. When the getToken function is called, an entry in the tokenPAN data structure 265 is created or updated. When the getPAN function is called, a lookup on the tokenPAN data structure 265 is performed to determine the PAN that is uniquely associated with the input token.

The biller data structure 270 includes at least a biller name and a remittance address. The scheduled payment data structure 250, payee data structure 260, or biller data structure 270 may include additional information depending on the design of the underlying database, and additional fields to capture other data about the corresponding scheduled payment, payee, or biller.

A historical payment data structure 280 includes data about previous payments made to a payee. Information stored in the historical payment data structure may include a payee identifier or name, an amount for the transaction, a date or time, a success indicator, a transaction identifier, an account number or reference, a token flag (used in a similar manner as the token flag in the payee data structure 260), a customer (e.g., user) number or identifier, or the like.

A biller mask data structure 290 includes data indicating how an account number or other reference number for a biller is formatted. For instance, a VISA® credit card account may be in the form of a sixteen-digit number with four groups of four numbers (e.g., NNNN-NNNN-NNNN-NNNN) with either dashes or spaces as separators. As another example, an AMERICAN EXPRESS® credit card account may be in the form of a fifteen-digit number with groups of four, six, and five numbers (e.g., NNNN-NNNNNN-NNNNN) with either dashes or spaces as separators. Other billers may use combinations of numbers or letters in various groups or formats. The biller mask data structure 290 stores the mask of an account reference corresponding to a biller.

The scheduled payments are saved in a pending transactions data store 202 (e.g., pending transactions database 116), which may be one or more tables in one or more databases or other database structured as described herein. Based on the pending transactions data store 202, the “Biller Import” task 204 is able to identify one or more billers for payments that are due in the pending transactions data store 202. The Biller Import task 204 returns the billers that are included in the pending transactions data store 202. The Biller Import task 204 may also perform other operations. For instance, the Biller Import task 204 may act on processed payments (e.g., payments processed in the last month or last year) to find billers where it makes sense to redirect to electronic payments. The set of billers may be stored as a result set for use in other processes.

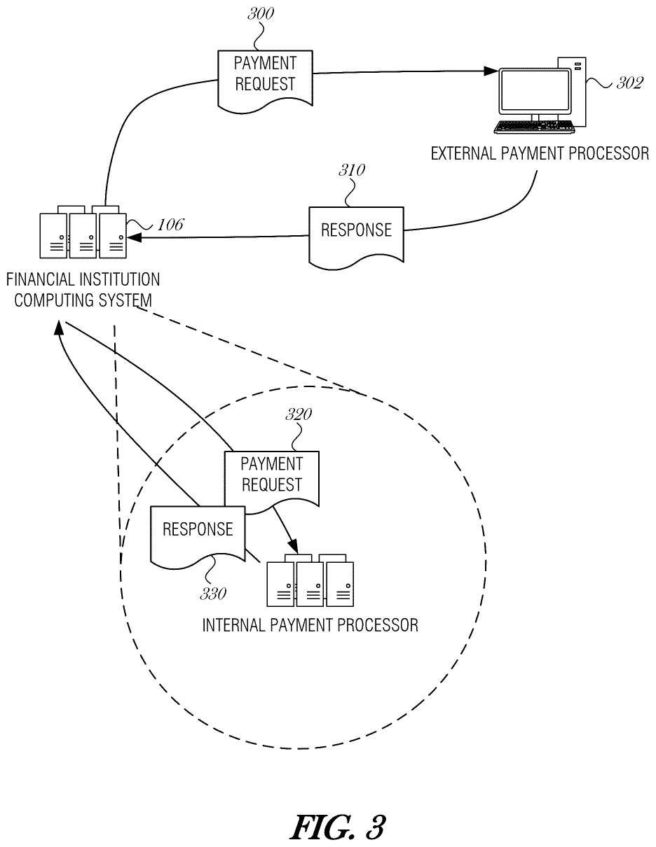

FIG. 3 is a diagram illustrating the four types of Bill Pay transactions, according to an embodiment. Bill Pay is performed using a request-response file model. A payment request file is sent to a system. After the payments are processed, the system sends a payment response file. The payment response file is used to confirm payments and settle the corresponding accounts.

When a payment request file is sent to an external payment processor 302 (e.g., at another financial institution, governmental agency, third-party provider, etc.) for settlement, an external outbound transaction 300 is used to send one or more payment request files to an external system(s). The files include actual PAN numbers because external systems do not understand the token values. After payment processing, an external inbound transaction 310 is performed where one or more response files are received from the external system(s). The response files include PAN values, which are replaced with tokens during the file intake process to reduce the amount of time the PAN values are stored in the clear.

For internal payment processors (e.g., hosted at the financial institution computing system 106, available by a subsidiary of the financial institution computing system 106, etc.), an internal outbound transaction 320 is used to send one or more request files to an internal payment processor 304. Here, the PAN is not used, and the token can be used to process the transaction. The token flag value is sent in this transaction to reduce overhead in later processing. An internal inbound transaction 330 is used to process one or more response files that are the result of the internal payment processing.

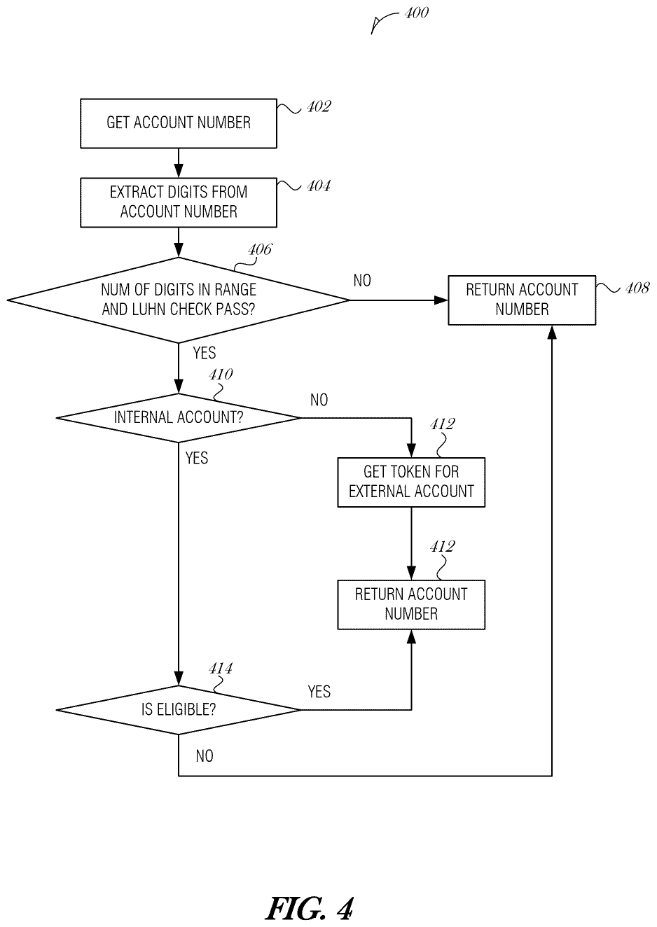

FIG. 4 is a diagram illustrating a process 400 for tokenizing a primary account number (PAN), according to an embodiment. At 402, an input account number is received. At 404, the digits are extracted from the input account number. A check is made at 406, to determine whether the number of digits is within a valid range. In an embodiment, the range is thirteen to nineteen, inclusive. In an embodiment, the range is twelve to nineteen, inclusive. Also at 406, a Luhn formula check is performed to ensure that the string of digits forms a valid account number. The Luhn formula is a mod 10 mathematical function. If the account number is not within the valid size range or does not pass the Luhn check, then the account is not a PAN, and the account number is returned (operation 408).

If the account number is within the valid size range and passes the Luhn check, then it is determined whether the account number is an internal account (operation 410). When the account number is not an internal account, then the account number can be still be tokenized, but additional processing may be performed to track this external account number (operation 412). If the account number is an internal account number, then at operation 414, it is determined if the account number is eligible to be tokenized. Eligibility of whether the account number can be tokenized may be based on various policies. If the account number is not eligible to be tokenized, then the account number is returned (operation 408), otherwise, a token is generated or accessed, and returned (operation 410). In operation 410, a token may have been previously created for an account number. Because token generation is a unique one-way hash, the same token value may not be regenerated if the same account number is used multiple times. In that case, the previously generated token is retrieved and returned in operation 410.

Token generation may be configured using various rules and checks. For instance, the token length may be made to match the length of the input account number. As another example, the last four digits of the token may be made to match the last four digits of the account number. Finally, a uniqueness test may be performed on the candidate token to ensure that it is unique with the system. A hash algorithm may be used to generate the first part of the token (less the last four digits). The hash algorithm may use a variety of inputs to seed the algorithm, such as the account number, a portion of the account number, a date or time stamp, a random number, or combinations of these types of information. The resulting hash value may be longer than needed and may be truncated (e.g., removing all but the first n or last n numbers), trimmed (e.g., removing numbers from the start and end of the string to result in (account number length—4) digits), or otherwise mathematically reduced to the correct length.

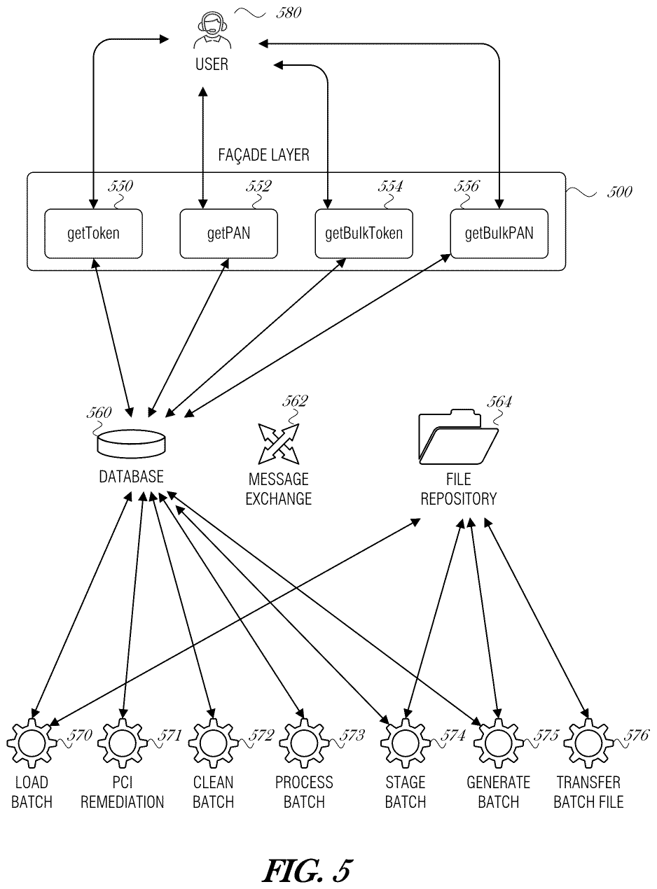

FIG. 5 illustrates the data and control flow in a system, according to an embodiment. An API (façade layer) 500 is provided that exposes a getToken endpoint 550, a getPAN endpoint 552, a getBulkToken endpoint 554, and a getBulkPAN endpoint 556. More or fewer endpoints may be implemented with the API 500. Middleware includes a database 560 (e.g., SQL Server, Oracle DB, DynamoDB, etc.), a message exchange 562 (e.g., Kafka, Amazon SQS, etc.), and a file repository 564.

Backend processes (e.g., services, applications, scripts, etc.) include a load batch process 570, a Payment Card Industry (PCI) remediation process 571, a clean batch process 572, a process batch process 573, a stage batch process 574, a generate batch process 575, and a transfer batch file process 576. The backend processes 570-576 may be implemented using services, one or more applications, a monolithic application, or the like. The backend executables invoke one or more of the endpoints 550-556 via the API 500. The backend processes 570-576 may be scheduled to execute at regular intervals, such as daily, hourly, or the like. The backend processes 570-576 may be invoked manually by a user 102. The backend processes 570-576 may be executed by a script, application, or other executable, which calls one or more of the backend processes 570-576 using conditional logic and other programmatic structures. The backend processes 570-576 form a basis for other applications to interface with the database 560 (e.g., tokenPAN data structure 265), the file repository, and other components of the financial institution computing system 106.

A user 580 may interface with the API 500 through a browser, client program, or the like, to invoke one or more of the endpoints 550-556. To create a token for a PAN, the user 580 may invoke the getToken endpoint 550 with an input value of an account number. The getToken endpoint 550 may perform the operations discussed above with reference to FIG. 4, and return an account number or a token value. Alternatively, the getToken endpoint 550 may be invoked with an account number and a staging table name. The getPAN endpoint 552 may then populate the provided staging table with the associated token value, token flag, and account number. In addition, in either mode of operation, the database 560 (e.g., tokenPAN data structure 265) is updated with the token value determined by the getPAN endpoint 552.

To obtain a PAN from a token, the user 580 may invoke the getPAN endpoint 552 with a token value as input. The database 560 (e.g., tokenPAN data structure 265) is referenced and the PAN corresponding to the token value is retrieved and returned. Alternatively, the getPAN endpoint 552 may be invoked with a token value and a staging table name. The getPAN endpoint 552 may then populate the provided staging table with the associated token value, token flag, and account number.

The getBulkToken endpoint 554 and getBulkPAN endpoint 556 act similar to their single action counterparts, except that the input for the endpoints 554, 556 is a staging table name. The staging table identified by the staging table name is accessed and each row in the staging table is operated on. Each row of the staging table includes various aspects of a transaction, including at least an account number, a token, and a token flag. The staging table is populated by the load batch process 570.

The getBulkToken endpoint 554 acts on transactions that are coming into the financial institution computing system 106 from an external source. In this situation, the staging table includes actual PAN numbers. In order to mask this sensitive information, the getBulkToken endpoint 554 is used to convert any PAN numbers found in the staging table to tokens. The getBulkToken endpoint 554 may be made more efficient by filtering for token flag, where the token flag is set to indicate that a token exists for the PAN. In this way, the getBulkToken endpoint 554 does not have to process non-PAN account numbers.

The getBulkPAN endpoint 556 acts on transactions that are being sent out from the financial institution computing system 106 to an external payment processor. In this situation, the staging table includes actual tokens, which are not understandable by the external payment processor. In order to add the sensitive account number information, the getBulkPAN endpoint 556 is used to obtain PAN numbers for token values found in the staging table. This is performed with a lookup in the database 560 (e.g., tokenPAN data structure 265) to obtain the PAN corresponding to the token value.

Turning now to the backend processes 570-576, each of these may be called individually or in series by a calling script, application, or other service. In addition, one of the backend processes 570-576 may call one or more of the other backend processes 570-576.

The load batch process 570 ingests an input file and populates a staging table. The load batch process 570 is typically used on inbound transactions (those coming from an external source). The input file may be stored in the file repository 564. The inbound file includes an account number, which may be a PAN, and other transactional data, such as a token flag, a transaction amount, a date and time stamp, etc. The load batch process 570 takes a staging table name as input and uses the staging table name to identify the table in the database 110 to modify. The load batch process 570 may first clear the staging table and then load at least the account number and, if available, the token flag into the staging table. Other transactional details may also be stored in the staging table depending on the design needs of the system.

The stage batch process 574 is similar to the load batch process 570 in that it is used to populate a staging table. However, the stage batch process 574 is the inverse of the load batch process 570 in that the stage batch process 574 is for outbound batch processing (transactions that are being sent to an external payment processor). As such, the stage batch process 574 is used to read data from one or more tables (e.g., payee database 114, pending transactions database 116, token database 118, etc.) in the database 110 and populate the staging table with the token, the token flag, and optionally other transaction details.

The PCI remediation process 571 is used to translate PAN values to token values or vice versa. The PCI remediation process 571 acts as a translation layer or proxy between the secured internal area where PANs are obscured with tokens, and the unsecured external area where PANs are transmitted in the clear. The PCI remediation process 571 takes as input a staging table name, a PAN column name, a token column name, a token flag column name, and a direction of the conversion (e.g., token-to-Pan or PAN-to-token). The staging table is populated by the load batch process 570. Depending on the direction of translation, either the PAN or the token column is populated by the load batch process 570, and the PCI remediation process 571 is used to resolve the other column.

The process batch process 573 is used to update one or more tables in the database 110. Here, tables are updated based on the stage of the transaction, whether the transaction was successful, to settle accounts, or the like. The clean batch process 572 is used to clear the PAN values from a staging table. The clean batch process 572 is implemented as soon as possible in the processing pipeline in order to reduce the amount of time the PAN values are stored in the clear. The generate batch process 575 is used to write the staging table to one or more outbound files. The outbound files may be stored in the file repository 564. The transfer batch file process 576 is used to transfer an outbound file to an external payment processor. This may be performed over a secure communication channel. The outbound file may be encrypted or otherwise secured.

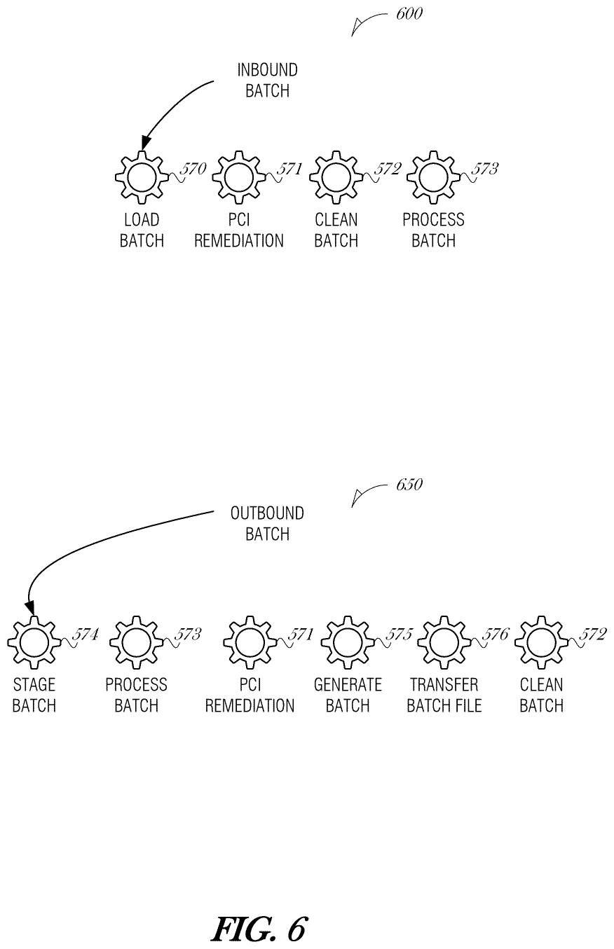

FIG. 6 is a diagram illustrating the operational flow for inbound and outbound batch pipelines, according to an embodiment.

The inbound batch pipeline 600 includes a call to the load batch process 570 to populate the staging table from an inbound file, then a call to the PCI remediation process 571 to populate the tokens in the staging table, then a call to the clean batch process 572 to remove PAN values from the staging table, and finally a call to the process batch process 573 to update other transactional tables corresponding with the completion of the inbound processing. Note, if the process batch process 573 requires PAN accounts in the clear, then the order of execution of the process batch process 573 and the clean batch process 572 may be swapped.

The outbound batch pipeline 650 includes a call to the stage batch process 574 to populate the staging table from the database 110, then a call to the process batch process 573 to update tables in the database 110, then a call to the PCI remediation process 571 to populate the PANs in the staging table, then a call to the generate batch process 575 to write the staging table to one or more outbound files, and then a call to the transfer batch file process 576 to transfer the outbound file(s) to an external payment processor, and finally a call to the clean batch process 572 to remove PAN values from the staging table. Note that the clean batch process 572 may be called prior to the transfer batch file process 576 to further reduce the time that the PAN values are stored in the clear. Additionally, if the process batch process 573 requires PAN accounts in the clear, then the order of execution of the process batch process 573 and the PCI remediation process 571 may be swapped.

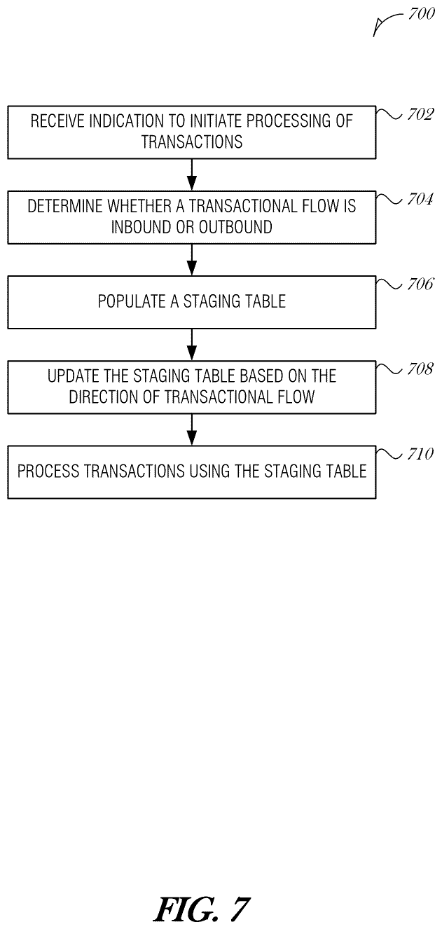

FIG. 7 is a flowchart illustrating a method 700 for processing Bill Pay transactions, according to an embodiment. The method 700 may be performed by an electronic system (e.g., platform 106) or any of the modules, logic, circuits, processors, or components described herein.

At 702, the method 700 includes the operation of receiving, from a client device, an electronic indication to initiate processing of Bill Pay transactions. In an embodiment, the electronic indication of the transaction is a Hypertext Transfer Protocol (HTTP) message request. In a further embodiment, the Hypertext Transfer Protocol (HTTP) message request is an eXtended Markup Language (XML) Simple Object Access Protocol (SOAP) message. In another embodiment, the Hypertext Transfer Protocol (HTTP) message request is a Representational State Transfer (REST) message.

In an embodiment, the electronic indication of the transaction is received through an application programming interface (API) exposed to the client device, wherein the API exposes a number of services provided by the system.

At 704, the method 700 includes the operation of determining whether a Bill Pay transactional flow is inbound or outbound. In an embodiment, determining whether a transactional flow is inbound or outbound includes determining the transactional flow based on parameters provided to a function call, where when a token column is provided to the function call, the transactional flow is inbound and when an account number column is provided to the function call, the transactional flow is outbound.

At 706, the method 700 includes the operation of populating a staging table in a database with at least one of an account number and a token, the token being a tokenized value of the account number. In an embodiment, populating the staging table in the database with at least one of an account number and a token includes depending on the transactional flow, reading a file to obtain account numbers and populate the staging table with the account numbers when the transactional flow is inbound and reading a table in the database to obtain tokens when the transactional flow is outbound, and populating the staging table with either the account numbers or the tokens based on the direction of the transactional flow.

At 708, the method 700 includes the operation of updating the staging table with account numbers given values of tokens in the staging table when the Bill Pay transactional flow is outbound, and updating the staging table with tokens given the account numbers in the staging table when the Bill Pay transactional flow is inbound.

In an embodiment, updating the staging table with account numbers given values of tokens in the staging table when the transactional flow is outbound includes accessing the database to lookup a candidate account number for a given token, and updating the staging table with the candidate account number for the given token.

In another embodiment, updating the staging table with tokens given the account numbers in the staging table when the transactional flow is inbound includes calculating a candidate token for a given account number, formatting the candidate token according to a format ruleset, and updating the staging table with the candidate token for the given account number. In a further embodiment, formatting the candidate token according to the format ruleset includes formatting the candidate token with the last four digits of the candidate token being the same as the last four digits of the account number. In another embodiment, formatting the candidate token according to the format ruleset includes formatting the candidate token with a length of the candidate token being the same as a length of the account number. In an embodiment, the method 700 includes checking that the candidate token is unique in the system.

At 710, the method 700 includes the operation of processing the Bill Pay transactions using the updated tokens or account numbers in the staging table. In an embodiment, the transactions comprise Bill Pay transactions.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

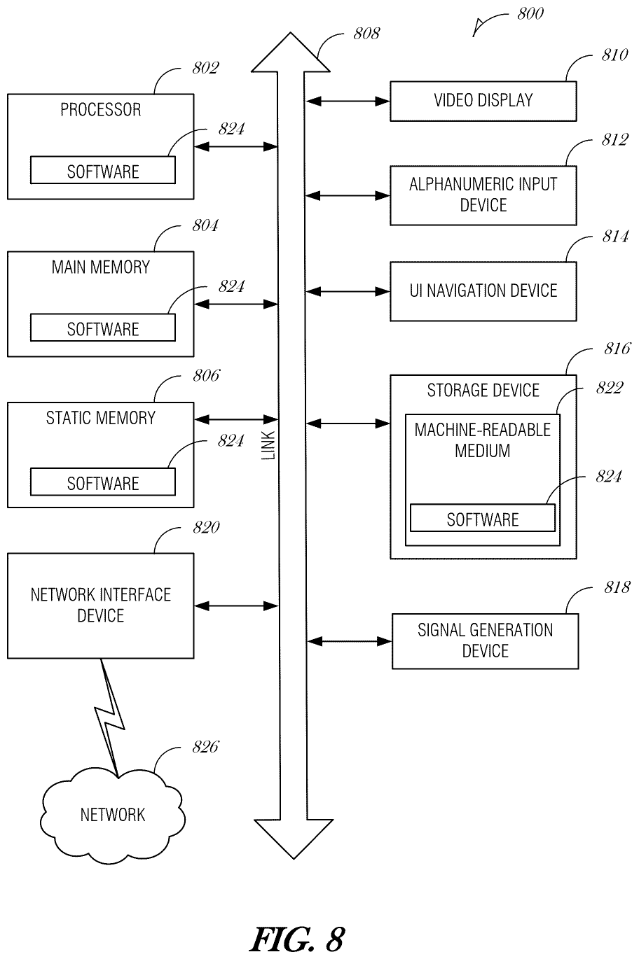

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system to tokenize and de-tokenize transactions during processing and interaction with external systems, the system comprising: a processor subsystem; and memory including instructions, which when executed by the processor subsystem, cause the processor subsystem to: receive, from a client device, an electronic indication to initiate processing of transactions; determine whether a transactional flow is inbound or outbound; populate a staging table in a database with at least one of an account number and a token, the token being a tokenized value of the account number; update the staging table with account numbers given values of tokens in the staging table when the transactional flow is outbound, and update the staging table with tokens given the account numbers in the staging table when the transactional flow is inbound; and process the transactions using the updated tokens or account numbers in the staging table.

In Example 2, the subject matter of Example 1 includes, wherein the electronic indication of the transactions is a Hypertext Transfer Protocol (HTTP) message request.

In Example 3, the subject matter of Example 2 includes, wherein the Hypertext Transfer Protocol (HTTP) message request is an eXtended Markup Language (XML) Simple Object Access Protocol (SOAP) message.

In Example 4, the subject matter of Examples 2-3 includes, wherein the Hypertext Transfer Protocol (HTTP) message request is a Representational State Transfer (REST) message.

In Example 5, the subject matter of Examples 1-4 includes, wherein the electronic indication of the transactions is received through an application programming interface (API) exposed to the client device, wherein the API exposes a number of services provided by the system.

In Example 6, the subject matter of Examples 1-5 includes, wherein to determine whether a transactional flow is inbound or outbound, the processor subsystem is configured to determine the transactional flow based on parameters provided to a function call, wherein when a token column is provided to the function call, the transactional flow is inbound and when an account number column is provided to the function call, the transactional flow is outbound.

In Example 7, the subject matter of Examples 1-6 includes, wherein to populate the staging table in the database with at least one of an account number and a token, the processor subsystem is configured to: depending on the transactional flow, read a file to obtain account numbers and populate the staging table with the account numbers when the transactional flow is inbound and read a table in the database to obtain tokens when the transactional flow is outbound; and populate the staging table with either the account numbers or the tokens based on a direction of the transactional flow.

In Example 8, the subject matter of Examples 1-7 includes, wherein to update the staging table with account numbers given values of tokens in the staging table when the transactional flow is outbound, the processor subsystem is configured to: access the database to lookup a candidate account number for a given token; and update the staging table with the candidate account number for the given token.

In Example 9, the subject matter of Examples 1-8 includes, wherein to update the staging table with tokens given the account numbers in the staging table when the transactional flow is inbound, the processor subsystem is configured to: calculate a candidate token for a given account number; format the candidate token according to a format ruleset; and update the staging table with the candidate token for the given account number.

In Example 10, the subject matter of Example 9 includes, wherein to format the candidate token according to the format ruleset, the processor subsystem is configured to: format the candidate token with a last four digits of the candidate token being the same as a last four digits of the account number.

In Example 11, the subject matter of Examples 9-10 includes, wherein to format the candidate token according to the format ruleset, the processor subsystem is configured to: format the candidate token with a length of the candidate token being the same as a length of the account number.

In Example 12, the subject matter of Examples 9-11 includes, wherein the processor subsystem is configured to check that the candidate token is unique in the system.

In Example 13, the subject matter of Examples 1-12 includes, wherein the transactions comprise Bill Pay transactions.

Example 14 is a method for processing transactions, performed on an electronic online system, the method comprising: receiving, from a client device, an electronic indication to initiate processing of transactions; determining whether a transactional flow is inbound or outbound; populating a staging table in a database with at least one of an account number and a token, the token being a tokenized value of the account number; updating the staging table with account numbers given values of tokens in the staging table when the transactional flow is outbound, and updating the staging table with tokens given the account numbers in the staging table when the transactional flow is inbound; and processing the transactions using the updated tokens or account numbers in the staging table.

In Example 15, the subject matter of Example 14 includes, wherein the electronic indication of the transactions is a Hypertext Transfer Protocol (HTTP) message request.

In Example 16, the subject matter of Example 15 includes, wherein the Hypertext Transfer Protocol (HTTP) message request is an eXtended Markup Language (XML) Simple Object Access Protocol (SOAP) message.

In Example 17, the subject matter of Examples 15-16 includes, wherein the Hypertext Transfer Protocol (HTTP) message request is a Representational State Transfer (REST) message.

In Example 18, the subject matter of Examples 14-17 includes, wherein the electronic indication of the transactions is received through an application programming interface (API) exposed to the client device, wherein the API exposes a number of services provided by the system.

In Example 19, the subject matter of Examples 14-18 includes, wherein determining whether a transactional flow is inbound or outbound comprises determining the transactional flow based on parameters provided to a function call, wherein when a token column is provided to the function call, the transactional flow is inbound and when an account number column is provided to the function call, the transactional flow is outbound.

In Example 20, the subject matter of Examples 14-19 includes, wherein populating the staging table in the database with at least one of an account number and a token comprises: depending on the transactional flow, reading a file to obtain account numbers and populate the staging table with the account numbers when the transactional flow is inbound and reading a table in the database to obtain tokens when the transactional flow is outbound; and populating the staging table with either the account numbers or the tokens based on a direction of the transactional flow.

In Example 21, the subject matter of Examples 14-20 includes, wherein updating the staging table with account numbers given values of tokens in the staging table when the transactional flow is outbound comprises: accessing the database to lookup a candidate account number for a given token; and updating the staging table with the candidate account number for the given token.

In Example 22, the subject matter of Examples 14-21 includes, wherein updating the staging table with tokens given the account numbers in the staging table when the transactional flow is inbound comprises: calculating a candidate token for a given account number; formatting the candidate token according to a format ruleset; and updating the staging table with the candidate token for the given account number.

In Example 23, the subject matter of Example 22 includes, wherein formatting the candidate token according to the format ruleset comprises: formatting the candidate token with a last four digits of the candidate token being the same as a last four digits of the account number.

In Example 24, the subject matter of Examples 22-23 includes, wherein formatting the candidate token according to the format ruleset comprises: formatting the candidate token with a length of the candidate token being the same as a length of the account number.

In Example 25, the subject matter of Examples 22-24 includes, checking that the candidate token is unique in the system.

In Example 26, the subject matter of Examples 14-25 includes, wherein the transactions comprise Bill Pay transactions.

Example 27 is a non-transitory machine-readable medium comprising instructions for processing transactions, which when executed by a machine in an online system cause the machine to: receive, from a client device, an electronic indication to initiate processing of transactions; determine whether a transactional flow is inbound or outbound; populate a staging table in a database with at least one of an account number and a token, the token being a tokenized value of the account number; update the staging table with account numbers given values of tokens in the staging table when the transactional flow is outbound, and update the staging table with tokens given the account numbers in the staging table when the transactional flow is inbound; and process the transactions using the updated tokens or account numbers in the staging table.

In Example 28, the subject matter of Example 27 includes, wherein the electronic indication of the transactions is a Hypertext Transfer Protocol (HTTP) message request.

In Example 29, the subject matter of Example 28 includes, wherein the Hypertext Transfer Protocol (HTTP) message request is an eXtended Markup Language (XML) Simple Object Access Protocol (SOAP) message.

In Example 30, the subject matter of Examples 28-29 includes, wherein the Hypertext Transfer Protocol (HTTP) message request is a Representational State Transfer (REST) message.

In Example 31, the subject matter of Examples 27-30 includes, wherein the electronic indication of the transactions is received through an application programming interface (API) exposed to the client device, wherein the API exposes a number of services provided by the system.

In Example 32, the subject matter of Examples 27-31 includes, wherein to determine whether a transactional flow is inbound or outbound, the instructions cause the machine to determine the transactional flow based on parameters provided to a function call, wherein when a token column is provided to the function call, the transactional flow is inbound and when an account number column is provided to the function call, the transactional flow is outbound.

In Example 33, the subject matter of Examples 27-32 includes, wherein to populate the staging table in the database with at least one of an account number and a token, the instructions cause the machine to: depending on the transactional flow, read a file to obtain account numbers and populate the staging table with the account numbers when the transactional flow is inbound and read a table in the database to obtain tokens when the transactional flow is outbound; and populate the staging table with either the account numbers or the tokens based on a direction of the transactional flow.

In Example 34, the subject matter of Examples 27-33 includes, wherein to update the staging table with account numbers given values of tokens in the staging table when the transactional flow is outbound, the instructions cause the machine to: access the database to lookup a candidate account number for a given token; and update the staging table with the candidate account number for the given token.

In Example 35, the subject matter of Examples 27-34 includes, wherein to update the staging table with tokens given the account numbers in the staging table when the transactional flow is inbound, the instructions cause the machine to: calculate a candidate token for a given account number; format the candidate token according to a format ruleset; and update the staging table with the candidate token for the given account number.

In Example 36, the subject matter of Example 35 includes, wherein to format the candidate token according to the format ruleset, the instructions cause the machine to: format the candidate token with a last four digits of the candidate token being the same as a last four digits of the account number.

In Example 37, the subject matter of Examples 35-36 includes, wherein to format the candidate token according to the format ruleset, the instructions cause the machine to: format the candidate token with a length of the candidate token being the same as a length of the account number.

In Example 38, the subject matter of Examples 35-37 includes, wherein the instructions cause the machine to check that the candidate token is unique in the system.

In Example 39, the subject matter of Examples 27-38 includes, wherein the transactions comprise Bill Pay transactions.

Example 40 is at least one machine-readable medium including instructions that, when executed by processing circuitry, cause the processing circuitry to perform operations to implement of any of Examples 1-39.

Example 41 is an apparatus comprising means to implement of any of Examples 1-39.

Example 42 is a system to implement of any of Examples 1-39.

Example 43 is a method to implement of any of Examples 1-39.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system to tokenize and de-tokenize transactions during processing and interaction with external systems, the system comprising:
a processor subsystem; and
memory including instructions, which when executed by the processor subsystem, cause the processor subsystem to:
receive, from a client device, an electronic indication to initiate processing of transactions;
determine whether a transactional flow is inbound or outbound;
populate a staging table in a database with at least one of an account number and a token, the token being a tokenized value of the account number;
update the staging table with account numbers given values of tokens in the staging table when the transactional flow is outbound, and update the staging table with tokens given the account numbers in the staging table when the transactional flow is inbound; and
process the transactions using the updated tokens or account numbers in the staging table.

2. The system of claim 1, wherein the electronic indication of the transactions is a Hypertext Transfer Protocol (HTTP) message request.

3. The system of claim 2, wherein the Hypertext Transfer Protocol (HTTP) message request is an eXtended Markup Language (XML) Simple Object Access Protocol (SOAP) message.

4. The system of claim 2, wherein the Hypertext Transfer Protocol (HTTP) message request is a Representational State Transfer (REST) message.

5. The system of claim 1, wherein the electronic indication of the transactions is received through an application programming interface (API) exposed to the client device, wherein the API exposes a number of services provided by the system.

6. The system of claim 1, wherein to determine whether a transactional flow is inbound or outbound, the processor subsystem is configured to determine the transactional flow based on parameters provided to a function call, wherein when a token column is provided to the function call, the transactional flow is inbound and when an account number column is provided to the function call, the transactional flow is outbound.

7. The system of claim 1, wherein to populate the staging table in the database with at least one of an account number and a token, the processor subsystem is configured to:
depending on the transactional flow, read a file to obtain account numbers and populate the staging table with the account numbers when the transactional flow is inbound and read a table in the database to obtain tokens when the transactional flow is outbound; and
populate the staging table with either the account numbers or the tokens based on a direction of the transactional flow.

8. The system of claim 1, wherein to update the staging table with account numbers given values of tokens in the staging table when the transactional flow is outbound, the processor subsystem is configured to:
access the database to lookup a candidate account number for a given token; and
update the staging table with the candidate account number for the given token.

9. The system of claim 1, wherein to update the staging table with tokens given the account numbers in the staging table when the transactional flow is inbound, the processor subsystem is configured to:
calculate a candidate token for a given account number;
format the candidate token according to a format ruleset; and
update the staging table with the candidate token for the given account number.

10. The system of claim 9, wherein to format the candidate token according to the format ruleset, the processor subsystem is configured to:
format the candidate token with a last four digits of the candidate token being the same as a last four digits of the account number.

11. The system of claim 9, wherein to format the candidate token according to the format ruleset, the processor subsystem is configured to:
format the candidate token with a length of the candidate token being the same as a length of the account number.

12. The system of claim 9, wherein the processor subsystem is configured to check that the candidate token is unique in the system.

13. The system of claim 1, wherein the transactions comprise Bill Pay transactions.

14. A method for processing transactions, performed on an electronic online system, the method comprising:
receiving, from a client device, an electronic indication to initiate processing of transactions;
determining whether a transactional flow is inbound or outbound;
populating a staging table in a database with at least one of an account number and a token, the token being a tokenized value of the account number;
updating the staging table with account numbers given values of tokens in the staging table when the transactional flow is outbound, and updating the staging table with tokens given the account numbers in the staging table when the transactional flow is inbound; and
processing the transactions using the updated tokens or account numbers in the staging table.

15. The method of claim 14, wherein the electronic indication of the transactions is received through an application programming interface (API) exposed to the client device, wherein the API exposes a number of services provided by the system.

16. The method of claim 14, wherein determining whether a transactional flow is inbound or outbound comprises determining the transactional flow based on parameters provided to a function call, wherein when a token column is provided to the function call, the transactional flow is inbound and when an account number column is provided to the function call, the transactional flow is outbound.

17. The method of claim 14, wherein populating the staging table in the database with at least one of an account number and a token comprises:
depending on the transactional flow, reading a file to obtain account numbers and populate the staging table with the account numbers when the transactional flow is inbound and reading a table in the database to obtain tokens when the transactional flow is outbound; and
populating the staging table with either the account numbers or the tokens based on a direction of the transactional flow.

18. The method of claim 14, wherein updating the staging table with account numbers given values of tokens in the staging table when the transactional flow is outbound comprises:
accessing the database to lookup a candidate account number for a given token; and
updating the staging table with the candidate account number for the given token.

19. A non-transitory machine-readable medium comprising instructions for processing transactions, which when executed by a machine in an online system cause the machine to:
receive, from a client device, an electronic indication to initiate processing of transactions;
determine whether a transactional flow is inbound or outbound;
populate a staging table in a database with at least one of an account number and a token, the token being a tokenized value of the account number;
update the staging table with account numbers given values of tokens in the staging table when the transactional flow is outbound, and update the staging table with tokens given the account numbers in the staging table when the transactional flow is inbound; and
process the transactions using the updated tokens or account numbers in the staging table.

20. The non-transitory machine-readable medium of claim 19, wherein to populate the staging table in the database with at least one of an account number and a token, the instructions cause the machine to:
depending on the transactional flow, read a file to obtain account numbers and populate the staging table with the account numbers when the transactional flow is inbound and read a table in the database to obtain tokens when the transactional flow is outbound; and
populate the staging table with either the account numbers or the tokens based on a direction of the transactional flow.
